(19) United States
(12) Patent Application Publication
(10) Pub. No.: US 2024/0093823 A1
(43) Pub. Date: Mar. 21, 2024

(54) A METHOD OF RELINING A SEWER PIPE

(71) Applicant: PER AARSLEFF A/S, Viby J (DK)

(72) Inventors: Bent SLOTH RASMUSSEN, Viby J (DK); Mogens PAGTER RASMUSSEN, Viby J (DK)

(21) Appl. No.: 18/035,162

(22) PCT Filed: Nov. 5, 2021
(86) PCT No.: PCT/EP2021/080814

§ 371 Date: May 3, 2023

(30) Foreign Application Priority Data
Nov. 6, 2020 (EP) 20206212.1

(51) Int. Cl. F16L 55/165

(52) U.S. Cl. CPC F16L 55/1651

(57) ABSTRACT

The invention relates to a method of relining a sewer pipe having an area in need of repair. The sewer pipe is accessed via an access bore having an upper end and a lower end, and an access point at the upper end, and connected to the sewer pipe at a bore-pipe junction at the lower end. The method comprises providing a liner for inserting inside the sewer pipe such that the sewer pipe is relined. The method further comprises providing a tube for inserting said liner into said sewer pipe, and everting the liner such that the liner is turned inside out and said inside surface constitutes a temporary outside surface, placing the everted liner inside the tube such that the tube includes the liner and constitutes a tube-liner assembly having a free end, and moving the tube-liner assembly into the access bore with the free end such that the free end of the tube-liner assembly extends into said sewer pipe, inverting the tube-liner assembly when the free end is at bore-pipe junction such that the liner being placed with the outside surface facing the sewer pipe and covering the area in need of repair.

The present invention relates to a method of relining a sewer pipe having an area in need of repair.

Pipelines are typically made of robust and heavy materials such as steel, concrete, clay or very rigid plastic. Exchanging existing pipelines is usually a costly process, especially when the pipeline or tank is located underground or in difficult accessible places such as sewage pipelines. It is therefore preferable to renovate the defective pipeline or tank instead of replacing it. For example, a process called relining is used to renovate a defective pipeline, such as a leaking sewage pipeline, in which process a fiber liner is inserted into the existing pipeline. The liner is generally made of woven or non-woven fibers is resin-impregnated and after mounting and cure has a shape like a tube having approximately the same diameter as the pipeline or tank.

Thus, it is desirable to use methods for locating a liner within a sewer pipe during pipeline repair of a sewer pipe having an area in need of repair and particularly during cured in-place pipeline repair (CIPP).

The process of CIPP involves inserting and running a felt lining into a preexisting pipe that is the subject of repair. Resin within the liner is then exposed to a curing element, such as e.g. steam or UV light, to make it attach to the inner walls of the pipe. Once fully cured, the lining now acts as a new pipeline.

The liner used in CIPP is typically a fabric tube, impregnated with a liquid resin. The liner can be formed inside of an existing conduit and cured to become a one-piece, continuous new pipelining. CIPP is used to renew main sewer pipes or lateral sewer pipes as well as other types of conduits. When using CIPP for renewing both main and lateral pipes, the lining is either pulled in place and inflated or inverted and inflated

An access bore or cleanout pipe is typical in all plumbing codes and therefore an access bore is common on lateral sewer pipes. The access bore provides one access point for entering the lateral sewer pipe. Another way of access is done remotely through a manhole into the main pipe and then into a lateral sewer pipe.

The liner may either be pulled into place or inverted into place. When a liner is pulled into place, either the lining has an outer coating or it does not have an outer coating. If the lining has an outer coating, the resin impregnated into the lining will remain contained within the coated tube preventing resin from migrating into pipe breaks and open joints. If the lining does not have an outer coating, the resin impregnated into the lining may be contaminated and even wiped off during the pulling in process. A pulled in-place liner requires two access points. One access point is a manhole, which is commonly located in public streets. The other access point may be another manhole or can also be a cleanout pipe. However, it is often undesirable to require two separate access points and it would generally be considered advantageous to require only one access point. The inversion method requires only one access point. It is generally a superior methodology to invert a liner, allowing the liner to be inserted into the pipe from only one access point, and allowing resin to contact the pipe directly and migrate into broken areas of the pipe without damaging the liner.

U.S. Pat. No. 7,448,413 discloses a method of locating a liner within a sewer pipe. A bladder tube is used to transport the liner to the broken area in the sewer pipe. During the transport the liner is attached to inner surface of the bladder tube by attachment means. The bladder tube is transported into the sewer pipe via an access pipe or a manhole. The bladder tube is forced into the access pipe and sewer pipe by means of compressed air and transported to the place in the sewer pipe where is should be located. The method requires a lot of preparation and very precise measurements of where the liner should be located in the sewer pipe.

An object of the present invention is to provide a method for repairing an area of a sewer piper, which method can be performed fast and uncomplicated by means of a liner and a bladder tube.

A further object of the present invention is to position the liner within the sewer pipe in a position adjacent the area to be repaired without blocking the sewer pipe

A further object, feature, or advantage of the present invention is to provide an inversion method for installing a liner/bladder tube assembly through an access bore that allows the bladder tube to be connected to an inversion machine outside the sewer pipe and allows the liner to be positioned in an area along the length (or portion of the length) of the sewer pipe

A further object of the present invention is to create a liner/bladder tube assembly wherein the liner is loosely attached to the bladder tube and the loose attachment is created without the need for expensive manufacturing equipment or factory settings, but can be done easily and efficiently in the field.

The above objects and other objects are achieved by the present invention.

The present invention relates to a method of relining a sewer pipe,
said sewer pipe having an area in need of repair, and an access via an access bore, said access bore having an upper end and a lower end, and an access point at said upper end, and being connected to said sewer pipe at a bore-pipe junction at said lower end,
said method comprising:
   providing a liner for inserting inside said sewer pipe such that said sewer pipe being relined, said liner having an inside surface, and an outside surface for facing said sewer pipe when said liner being in its intended position in said sewer pipe after said relining,
   providing a tube for inserting said liner into said sewer pipe,
   everting said liner such that said liner is turned inside out and said inside surface constitutes a temporary outside surface,
   placing said everted liner inside said tube such that said tube includes said liner and constitutes a tube-liner assembly, said tube-liner assembly having a free end,
   moving said tube-liner assembly into said access bore with said free end of said tube-liner assembly first such that said free end of said tube-liner assembly extends into said sewer pipe,
   inverting said tube-liner assembly when said free end being at said bore-pipe junction
such that said liner being placed with said outside surface facing said sewer pipe and covering said area in need of repair.

The area in need of repair may be a local area in the sewer pipe, which may only have an extension in the longitudinally direction of the pipe of % meter or less. However, the area in need of repair may also have a significant longer extension, such as several meter. The area in need of repair may comprise fractures forming holes and/or cracks making the sewer pipe leaky.

The access bore is substantially vertical in respect of ground level or horizontal, and the upper end is preferably located at ground level and the lower end is communicating with the sewer pipe via the bore-pipe junction. The sewer pipe extends substantially perpendicular to the access bore. By the term “extends substantially perpendicular” is meant that the center axis of the sewer pipe may deviate from forming and angle of 90 degree with the center axis of the access bore. The angle between the center axis of the sewer pipe and the center axis of the access bore may be in the range of 65 to 115 degrees, such as in the range of 80 to 100 degrees. Thus, the sewer pipe may have an inclination, which may serve to provide a flow in a liquid.

The sewer pipe may be a main sewer pipe, a lateral sewer pipe or any other type of sewer pipes and conduits. The tube is preferably a bladder tube which can be inflated to apply pressure onto the inner sewer pipe wall. Such tubes are well-known in the art. The bladder tube is preferably made from polymer material, such as polyethylene, polypropylene and similar material. Liners for lining a sewer pipe are also known in the art, such liners can be made from felt or non-woven of polymer material, such as polyester or similar material and impregnated with a curable resin. The resin is cured when the liner is located on the predetermined area in a sewer pipe.

In an embodiment of the method, the method comprises folding the tube-liner assembly at the free end such that the tube-liner assembly has a fold such that the fold unfolds when the free end reaches down into the sewer pipe at the bore-pipe junction. The fold helps to ensure that the tube-liner enters the sewer pipe correctly.

Preferably the bladder tube is not inflated or pressurized when the tube-liner assembly is lead into the access bore, as this would make it difficult to provide a fold in the tube-liner assembly.

Preferably the tube-liner assembly is placed in the access bore such that said fold unfolds facing with the free end in the direction of said area in need of repair. The free end is the end of the tube comprising an opening where the liner can enter and leave the interior of the tube.

In an embodiment the method comprises providing an insertion tool having a tool end for pushing said tube-liner assembly into and inside the access bore. Thus, the method in an embodiment comprises the step of pushing the tube-liner assembly in the access bore by means of the insertion tool. This facilitates the insertion of the tube-liner assembly in the access bore.

Preferably the method comprises placing the insertion tool end at the fold of the tube-liner assembly. This will improve the control of the insertion of the tube-liner assembly. The tool may be a rod or stick, and the tool end may comprise and expanded part to engage with the fold in the tube-liner assembly.

In an embodiment of the method according to the invention, the liner has a liner part extending outside the tube at the free end. Preferably liner part extending outside the tube has a length of at least 1 cm such as 2 cm or 3 cm or 4 cm or more, such as between 10 and 20 cm.

In an embodiment of the method, the method comprises the step of rolling a liner part back around the tube such that the liner part surrounding the tube on the outside of the tube at the free end. The step of rolling the liner part back around outside of the tube serves to obtain better control of the liner when the liner is to be mounted in the area in need of repair.

In an embodiment the method comprises attaching a first string to the free end of the liner for guiding the tube-liner assembly at the bore-pipe junction. By attaching a string to free end of the liner, i.e. the liner part extending outside the tube, it is possible to obtain better control over the guiding of the tube-liner assembly at the bore junction. The string may extend through the access bore to above ground level where an operator can use the string to control the guiding.

The method also includes an embodiment, comprising attaching a second string to the free end of said liner for guiding the tube-liner assembly at said bore-pipe junction. By using two strings it is possible to obtain an event better control over the guiding procedure at the bore-pipe junction.

According to the method an embodiment comprises placing the everted liner inside the everted tube. The entire length of the everted liner may be placed inside the tube or a liner part may extend outside the free end of the tube.

In an embodiment the method comprises everting part of the tube. The step of everting a part of the tube, such that the tube has an everted part and a non-everted part may facilitate mounting of the liner in the sewer part.

In an embodiment the tube has a non-everted part having a length substantially equal to the length of said access bore.

The method also provides an embodiment where the non-everted part has a length not greater or smaller than 25% of the length of the access bore. Thus, the non-everted part may have a length which is 25% shorter than the length of the access bore up to a length which is 25% longer that the length of the access bore.

Although, the tube-liner assembly can be moved and guided into the sewer pipe by use of any conventional tool such as a pig, it is preferred that the tube-liner assembly is moved by means of compressed air. Movement be means of compressed air is convenient and easy to control.

In an embodiment the tube is a bladder tube, which is suitable for use with compressed air.

Preferably the method also comprises curing the liner. The liner may be cured by any known methods and depending on the resin used in the liner, the curing may e.g. be performed by use of steam or UV light.

In an embodiment of the method the sewer pipe extends substantially horizontally such that the angle compared to horizontal does not exceed 25 degrees.

The method includes an embodiment comprising providing an inversion drum, and attaching the tube to the inversion drum. An inversion drum is well-known within the art and suitable for use when a tube is inserted into a sewer pipe and made provide air-pressure to inflate the tube to bring the liner in place.

In an embodiment a part of the tube-liner assembly is rolled up on the inversion drum. Thus, the inversion drum may assist in placing the tube-liner assembly in the sewer pipe.

The method also includes an embodiment comprising providing a shoehorn tool for directing the tube-liner assembly from the access bore into the sewer pipe. The shoehorn tool has a shoehorn end, and the shoehorn tool is placed in the access bore such that the shoehorn end extends down into the bore-pipe junction. A shoehorn is a well-known tool within the art and may facilitate the placing of the tube-liner assembly in the sewer pipe. The shoehorn tool may guide the tube-liner assembly upstream or downstream in the sever pipe.

Preferably the shoehorn tool is configured as a rod and preferably having a plate at the shoehorn end.

In an embodiment the shoehorn end is inclined, such that the inclination of the shoehorn end reduces the angle between the access pipe and the liner from a 90 degree bend to a lower bending degree, such as between 40 to 50 degree, such as degree, for bending the tube-line assembly at the bore-pipe junction.

It is clear that the method may include other features known in the art, such as cameras, detectors and curing devises.

The invention will now be described in further details with reference to drawings in which:

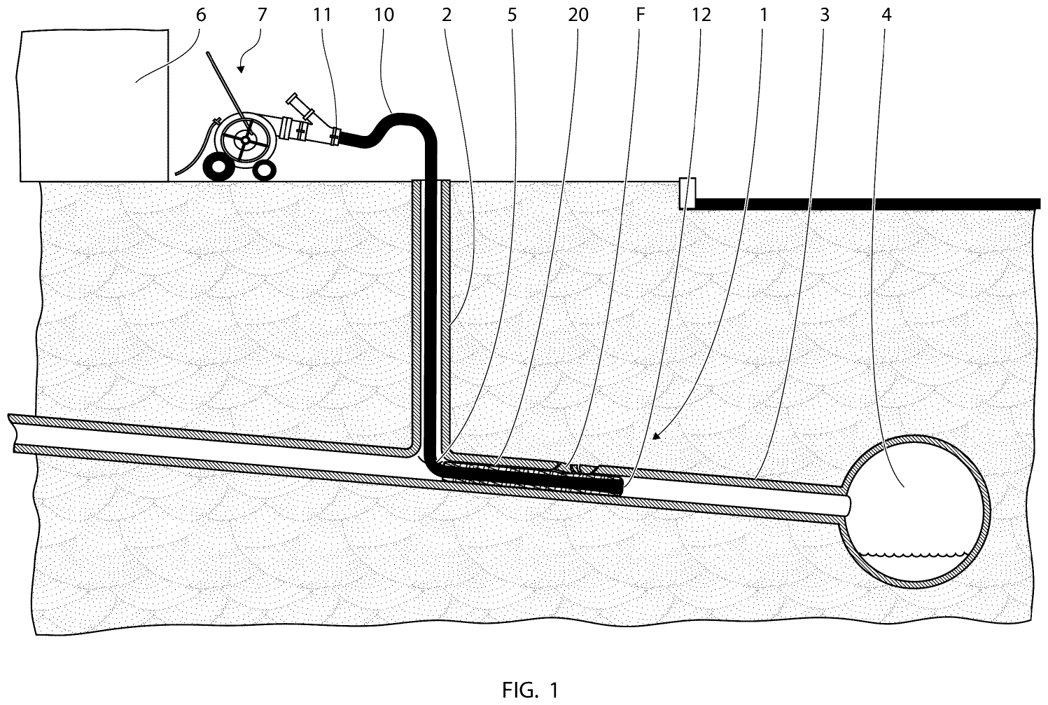

FIG. 1 shows the principle of the invention;

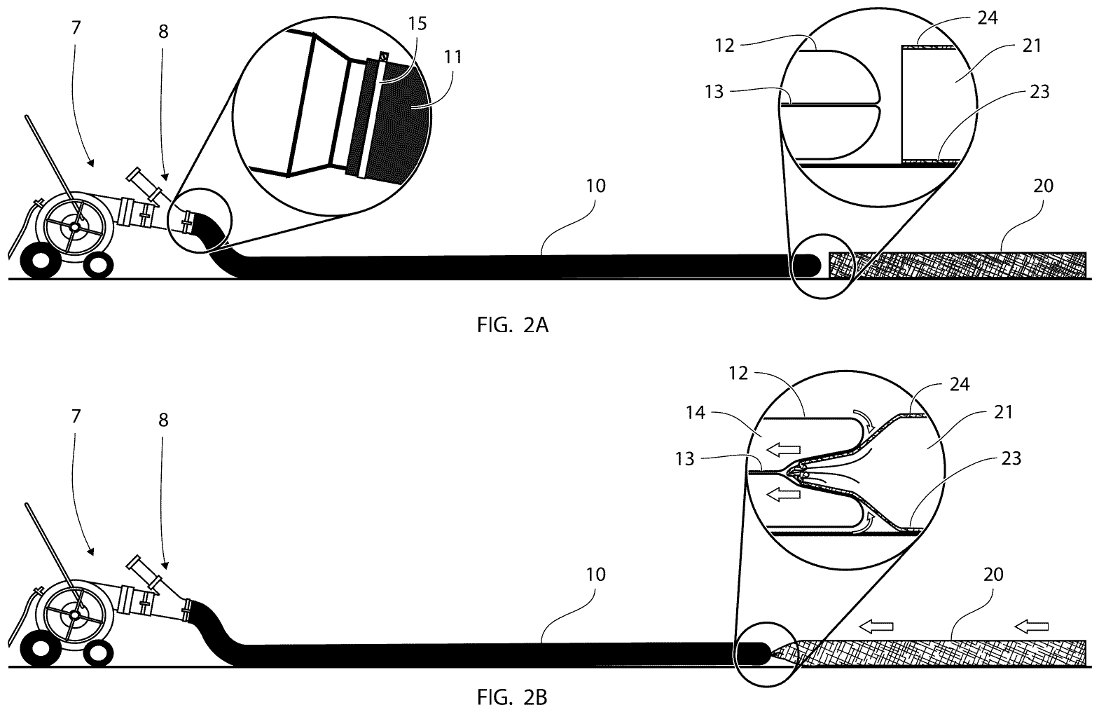

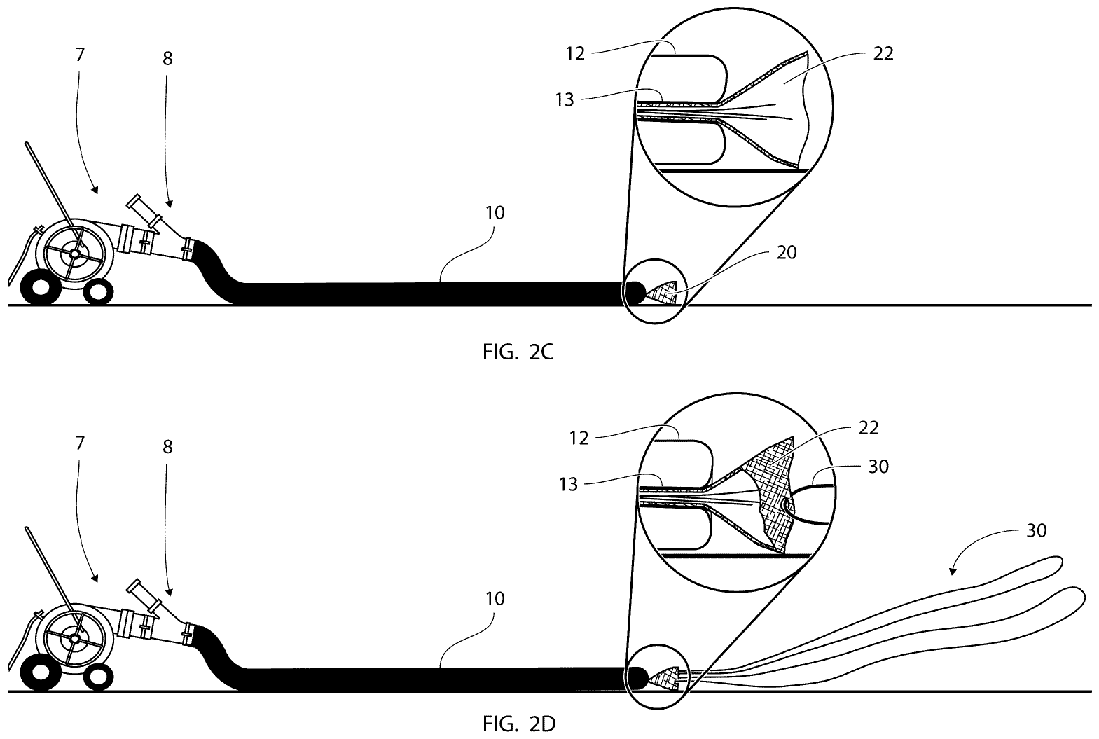

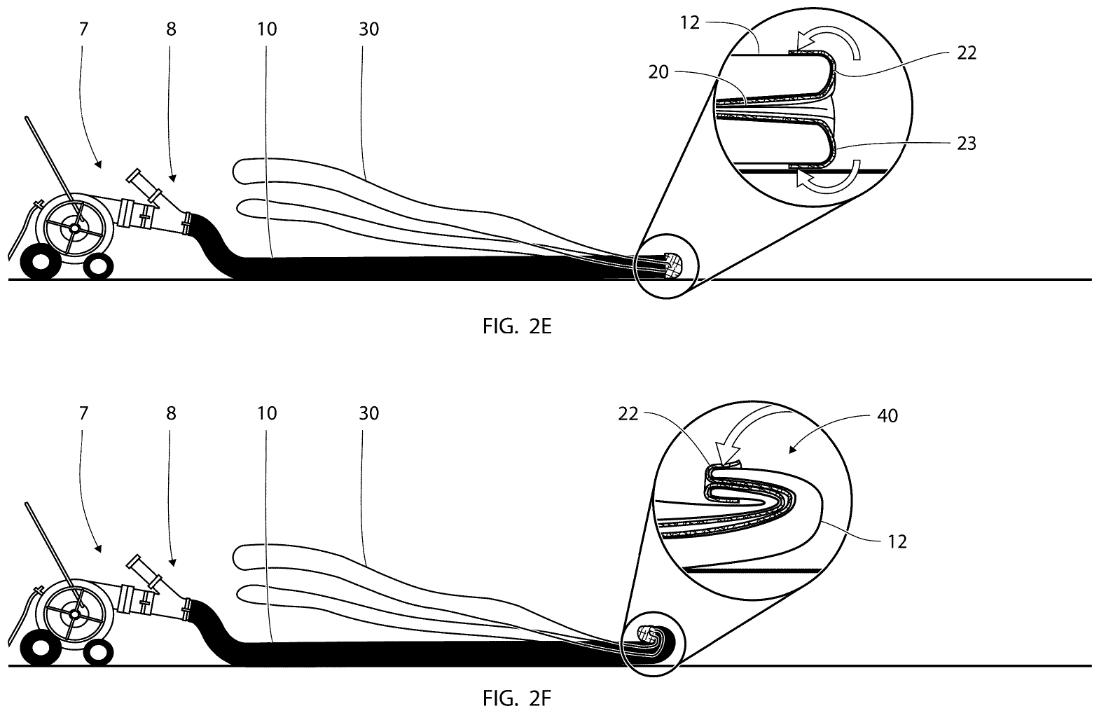

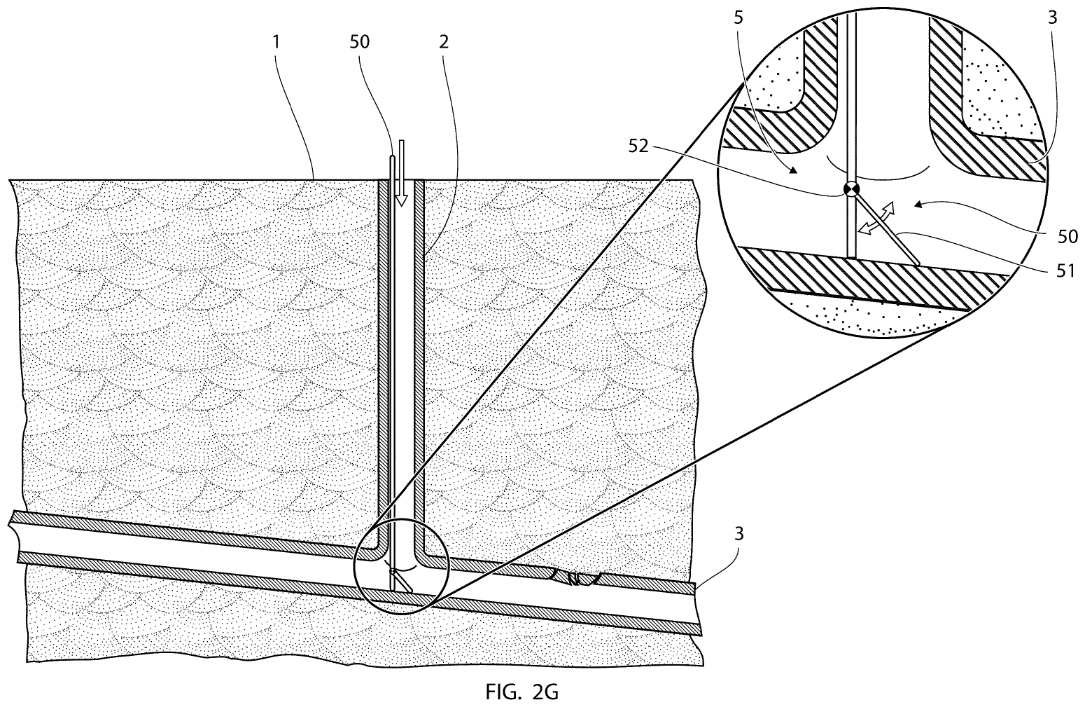

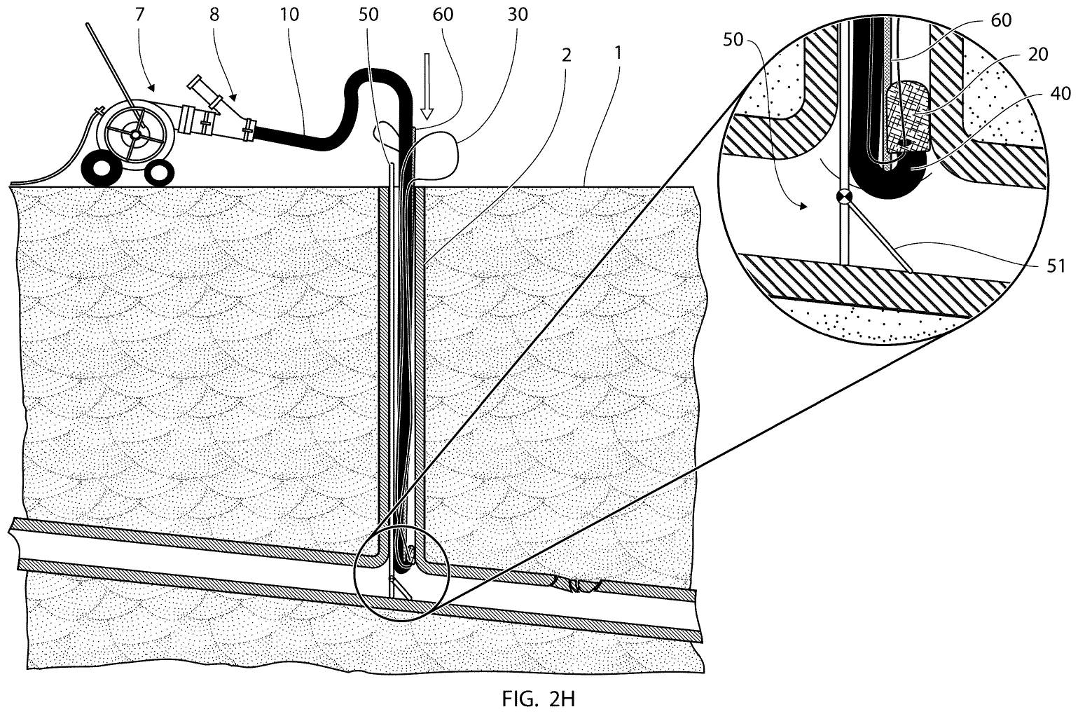

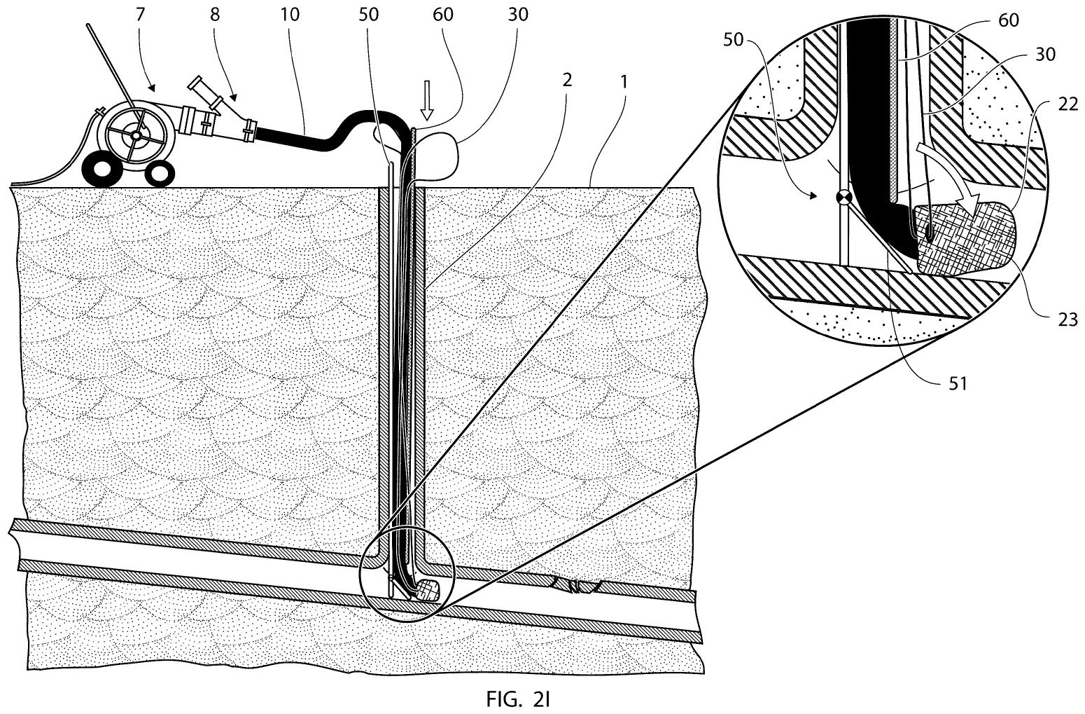

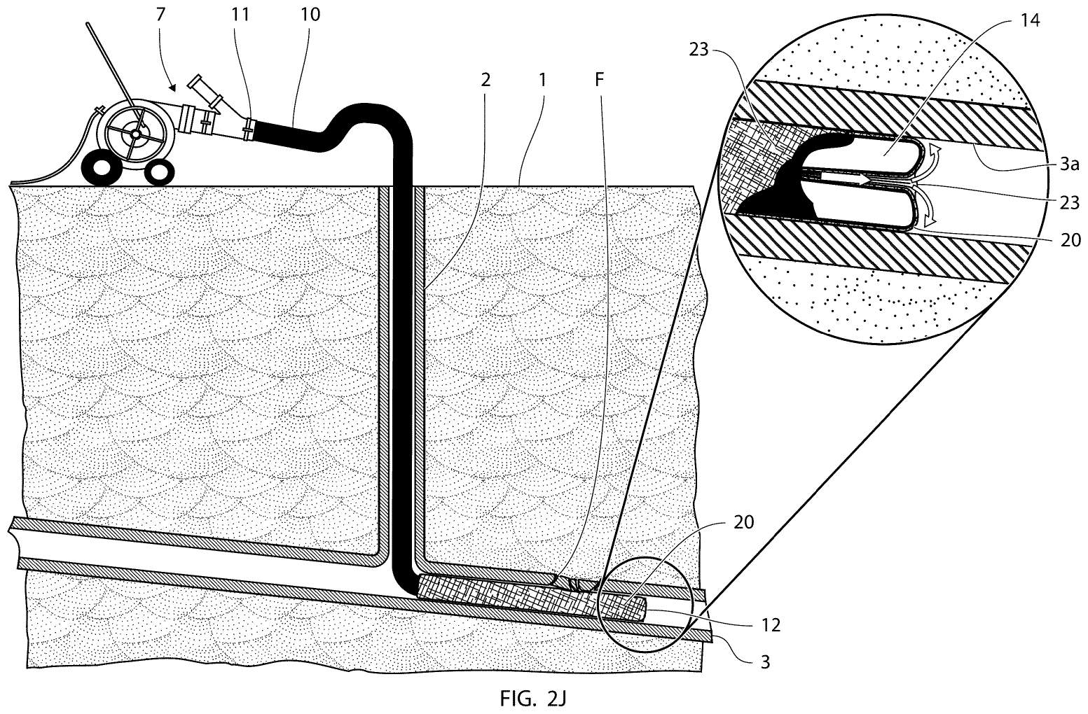

FIG. 2A shows the everted tube and everted liner;

FIG. 2B shows the everted liner pulled into the everted tube;

FIG. 2C shows the everted liner with free end outside the everted tube;

FIG. 2D shows a string attached to the free end;

FIG. 2E shows the free end of the liner rolled up on the tube;

FIG. 2F shows the tube with a fold;

FIG. 2G shows a shoehorn in the access bore

FIG. 2H shows the insertion of the tube-liner assembly in the access bore;

FIG. 2I shows the insertion of the tube-liner assembly into the sewer pipe;

FIG. 2J shows the liner being mounted in the sewer pipe.

The figures are only intended to illustrate the principles of the invention and may not be accurate in every detail. Moreover, parts which do not form part of the invention may be omitted. The same reference numbers are used for the same parts.

FIG. 1 shows cut through a sewer system 1 in connection with a house 6. The sewer system comprises an access bore 2 and a sewer pipe 3 leading to a main sewer conduit 4. In the sewer system 1 shown in FIG. 1 the sewer pipe 3 suffers from a fracture at point F, downstream in respect of the access bore 2.

In FIG. 1 is illustrated how the tube 10 has located a liner 20 in the sewer pipe 3 at the location of the fracture F by the method according to the invention.

The (bladder) tube 10 is connected to an inversion drum 7 at one end 11, and, the free end 12 of the tube 10 has been guided into the sewer pipe 3 via the access bore 2 and the bore-pipe junction 5 such that the liner 20 can be located at the point of fracture F. In FIG. 1 the inversion drum 7 has inflated the tube 10 such that the tube 10 squeezes/presses the outer surface of the liner 20 towards the inner surface of the sewer pipe 3 such that the liner is held in place while a curing takes place.

FIG. 2A shows the tube 10 connected with the inversion drum 7. A part of the tube has been everted by taking the free end (not shown) of the tube and moving it inside the tube and rolling it up onto the inversion drum—the close up view in FIG. 2A illustrates that part of the tube has been everted and located inside the tube.

The liner 20 has been everted (turned inside out) and is ready to be placed inside the tube 10.

The end 21 of the liner 20 is located close to the opening 12 of the tube 10. The everted tube 10 comprises a cavity 13 for receiving the liner. As the liner 20 is everted the outer surface 23 (which is intended to face the inner surface of the sewer pipe) is facing inwards and the inner surface 24 is facing outwards.

FIG. 2A also shows a close-up of the attachment of the end 11 of the tube 20 to the connection 8 of the inversion drum 7. The end 11 is attached to the connection 8 by means of a clamp 15. The clamp 15 ensures a very tight attachment of the tube 10 to the inversion drum 7, even when the tube 10 is pressurized.

FIG. 2B shows the everted liner 20 being pulled into the everted tube 10, thereby, forming a tube-liner assembly.

The movement of the everted liner 20 is indicated by arrows in FIG. 2B, and in the close up in FIG. 2B it can be seen how the end 21 of the liner 10 is pulled into the cavity 13, formed in the bladder part 14 of the tube 10.

In FIG. 2C the everted liner 20 has been pulled into the everted tube 10, thereby, forming a tube-liner assembly. The liner 20 is pulled into the cavity 13 of the tube 20 apart from a free liner part 22 extending from the open end 12 of the tube 10

As illustrated in FIG. 2D the free part 22 of the liner 20 extending from the open end 12 of the tube 10 may be connected with two strings such as a first string 30. Such a string or couple of strings may serve to guide the tube-liner assembly into the sewer pipe and also hold on to the liner so that it does not move when pressure is applied inside the (bladder) tube.

As shown in FIG. 2E the liner part 22 extending from the open end of the tube 12 is rolled up on the outer side of the tube 10. Most of the everted liner 20 remains inside the tube 10 forming the tube-liner assembly. The liner part 22 rolled up on the outer side of the tube 10 now has the outer side 23 of the liner 10 facing outwards, and, thus, ready to contact the inner surface of the sewer pipe. So that as soon pressure is applied to the tube, the free part of the liner is pressed onto the sewer pipe wall. This may ensure that the liner is held in place as it is being inverted into the sewer pipeline.

FIG. 2F illustrates how a fold 40 is made by the tube-liner assembly proximate the open end 12 of the tube 10—the fold is further from the open end than the length of the free part of the liner that is rolled up.

FIG. 2G shows a part of the sewer system 1 comprising the access bore 2 and the sewer pipe 3 where a shoehorn tool 50 has been inserted in the access bore 2. The part of the shoehorn tool 50 present in the bore-pipe junction 5 has a pivotable part 51 which is a plate 52 adapted to pivot around the hinge 52. The shoehorn tool 50 can provide an access from the access bore 2 into the sewer pipe 3 with an angle of about 45 degrees, which makes it easier to guide the tube-liner assembly into the sewer pipe 3.

In FIG. 2H the tube-liner assembly with the folded end 40 is lead into the access bore 2 towards the sewer pipe 3. The tube-liner assembly comprising the tube 10 and the liner 20 is pushed down in the access bore 2 towards the sewer pipe 3 by means of a rod 60. The downward end of the rod 60 is placed in the fold 40 of the tube-liner assembly, which feature serves to facilitate the insertion of the tube-liner assembly into the access bore 2.

The shoehorn tool 50 may also be placed in the access bore 2 and when the folded part 40 of the tube-liner assembly reaches the plate 51 of the shoehorn tool 50, the fold 40 will unfold. This is illustrated in FIG. 2I. In general, the fold is to unfold when it reaches the junction and the opening into the sewer pipe.

As mentioned, FIG. 2I illustrates the situation where the tube-line assembly unfolds the folded part 40 and enters into the sewer pipe 3. The folded part 40 has reached the plate 51 of the shoehorn tool 50 and starts unfolding as illustrated by arrow in the close-up in FIG. 2I. The free liner part 22 enters the sewer pipe 3 during the unfolding, such that the tube-liner assembly comprising the tube 10 and liner 20 subsequently can enter the sewer pipe 3. The rod 60 and the strings 30 may be used to assists the unfolding of the tube-liner assembly and entrance into the sewer pipe 3. The free liner part 22 of the liner 20 enters the sewer pipe with the outer surface 23 facing outwards and, is, thus, ready to engage with the inner surface of the sewer pipe. The tube-liner assembly is then ready to be inverted, which may be done by applying pressure in the inversion drum so that the tube-liner assembly is pressed out of the open end of the tube down at the junction.

FIG. 2J including the close-up view shows the inversion process in action, with the tube 10 inside the sewer pipe 3 with the liner 20 on its outer side pressing against the inner surface of the sewer pipe 3a at the place of fracture. The tube 10 connected with the inversion drum 7 at one end 11 extends down the access bore 2 into the sewer pipe 3 to the place of fracture F. The tube 10 extends longer into the sewer pipe 3 than the place of fracture F, such that the open end 12 of the tube 10 has passed the place of fracture.

Thereby it is possible to place the liner 20 such that the liner 20 covers areas upstream and downstream the place of fracture F, ensuring that the place of fracture F and areas adjacent to the place of fracture are covered by the liner 20.

When the entire length of the liner 20 has been pulled out of the cavity 13 in the tube 10, the liner 10 will be located in the sewer pipe 3 as seen in FIG. 1. The liner 20 is then cured and the tube is removed from the sewer system and the repair is completed.

1. A method of relining a sewer pipe,
said sewer pipe having an area in need of repair, and an access via an access bore, said access bore having an upper end and a lower end, and an access point at said upper end, and being connected to said sewer pipe at a bore-pipe junction at said lower end,
said method comprising:
providing a liner for inserting inside said sewer pipe such that said sewer pipe is relined, said liner having an inside surface, and an outside surface for facing said sewer pipe when said liner is in its intended position in said sewer pipe after said relining,
providing a tube for inserting said liner into said sewer pipe,
everting said liner such that said liner is turned inside out and said inside surface constitutes a temporary outside surface,
placing said everted liner inside said tube such that said tube includes said liner and constitutes a tube-liner assembly, said tube-liner assembly having a free end,
moving said tube-liner assembly into said access bore with said free end of said tube-liner assembly first such that said free end of said tube-liner assembly extends into said sewer pipe,
inverting said tube-liner assembly when said free end is at said bore-pipe junction such that said liner is placed with said outside surface facing said sewer pipe and covering said area in need of repair.

2. The method according claim 1, comprising folding said tube-liner assembly at said free end such that said tube-liner assembly has a fold such that said fold unfolds when said free end reaches down into said sewer pipe at said bore-pipe junction.

3. The method according to claim 2, said tube-liner assembly being placed in said access bore such that said fold unfolds facing with the free end in the direction of said area in need of repair.

4. The method according to claim 3, comprising providing an insertion tool having a tool end for pushing said tube-liner assembly inside said access Pipe.

5. The method according to claim 4, comprising pushing said tube-liner assembly in said access bore by means of said insertion tool.

6. The method according to claim 5, comprising placing said insertion tool end at said fold.

7. The method according to claim 1 said liner having a liner part extending outside said tube at said free end.

8. The method according to claim 7, said liner part having a length of at least 1 cm, such as 2 cm or 3 cm or 4 cm.

9. The method according to claim 8, comprising rolling said liner part back around said tube such that said liner part surrounds said tube on the outside of said tube at said free end.

10. The method according to claim 1, comprising attaching a first string to said free end of said liner for guiding said tube-liner assembly at said bore-pipe junction.

11. The method according to claim 10, comprising attaching a second string to said free end of said liner for guiding said tube-liner assembly at said bore-pipe junction.

12. The method according to claim 1, comprising placing said everted liner inside said everted tube.

13. The method according to claim 12, comprising an everting part of said tube.

14. The method according to claim 13, said tube having a non-everted part having a length substantially equal to the length of said access bore.

15. The method according to claim 14, said non-everted part having a length not greater or smaller than 25% of the length of said access pipe.
